(19) United States
(12) Patent Application Publication
(10) Pub. No.: US 2026/0316594 A1
(43) Pub. Date: Oct. 15, 2026

(54) Flywheel-Battery Hybrid Energy Storage System

(71) Applicant: KINETIC POWER LIMITED, London (GB)

(72) Inventor: Ross Martin Green

(21) Appl. No.: 19/104,159

(22) PCT Filed: Aug. 17, 2022
(86) PCT No.: PCT/EP2022/072938

§ 371 Date: Feb. 14, 2025

(51) Int. Cl. B60L 50/30; B60L 50/60; B60L 58/10; H02J 7/00; H02J 7/34; H02J 7/96; H02J 15/30

(52) U.S. Cl. CPC B60L 50/30; B60L 50/60; B60L 58/10; H02J 7/34; H02J 7/855; H02J 7/965; H02J 15/30; B60L 2200/18

(57) ABSTRACT

There is provided a hybrid energy storage system (200), comprising: a flywheel energy storage device (110) having a flywheel (120), a motor-generator (130) coupled to the flywheel, and a drive circuit (140) arranged to drive the motor-generator; a battery (250) coupled to the drive circuit via a DC link (160); and a controller (280). The controller is operable to increase and decrease an energy flow between the battery and the DC link to a target power level by controlling the drive circuit, based on the target power level, a voltage of the DC link and a state of the battery, to cause the motor-generator to adjust a rotation speed of the flywheel such that the voltage of the DC link is changed to a target DC link voltage that causes the energy flow between the battery and the DC link to be at the target power level.

### FIELD

Example aspects herein generally relate to the field of hybrid energy storage systems and, more particularly, to flywheel-battery hybrid energy storage systems.

### BACKGROUND

Vehicles of various kinds can be driven by electrical means to reduce their emission footprint. Such vehicles may be categorised either as electric vehicles, wherein the prime mover is an electric traction drive, or hybrid electric vehicles, wherein the prime mover is a hybrid system having both an electric traction drive and an internal combustion engine. In both cases, the electric traction drive must draw energy from an energy storage device, which is typically provided in the form of an electrochemical battery, although other options, such as hydrogen fuel cells, are also available.

At present, battery-powered electric vehicles are, in some respects, inferior to vehicles powered by internal combustion engines. Batteries tend to be substantial both in terms of size and weight, and to have significant charging times, owing to the vehicle's energy requirements. Further, to increase the lifetime of the batteries, their maximum charge and discharge rates tend to be limited. During the use of an electric vehicle, micro-cycling of its battery (i.e. fluctuations over short timescales in the energy flow in and out the battery) tends to occur frequently, particularly in urban environments, which can significantly reduce the battery's lifetime.

To address some of these issues, hybrid energy storage systems have been developed, wherein a battery, acting as the primary energy store for the prime mover of the electric vehicle, is supplemented by one or more secondary energy stores. Examples of such secondary energy stores include capacitors, supercapacitors, batteries with different characteristics to the primary battery, and flywheels. These secondary energy stores typically serve to cater for peak power demands by responding to peaks in power demand, alongside the primary battery, with a higher charge/discharge rate than is normally permitted by the primary battery. Hybrid energy storage systems can thus provide an overall performance beyond the capability of any individual elements in isolation.

In hybrid energy storage systems that include a battery, a battery interface module (BIM) is normally used to control the energy flow to and from the battery, dependent on its state. This power electronics component takes up space and adds weight to the energy storage system, and may also reduce its efficiency, owing to losses that occur in the BIM. These drawbacks would be more pronounced in high-power applications of the energy storage system, for example in an electric bus, where the BIM would be large and heavy, owing to its high power-handling requirements.

### SUMMARY

The present inventors have devised, in accordance with a first example aspect herein, a hybrid energy storage system, which comprises a flywheel energy storage device having a flywheel, a motor-generator coupled to the flywheel, and a drive circuit arranged to drive the motor-generator. The hybrid energy storage system further comprises a battery coupled to the drive circuit via a DC link, a battery state sensor arranged to determine a state of the battery, a voltage sensor arranged to determine a voltage of the DC link, and a controller. The controller is operable to increase an energy flow between the battery and the DC link from a first power level to a target power level by controlling the drive circuit, based on the target power level, the determined voltage of the DC link and the determined state of the battery, to cause the motor-generator to adjust a rotation speed of the flywheel such that the voltage of the DC link is changed to a target DC link voltage that causes the energy flow between the battery and the DC link to be at the target power level. The controller is further operable to decrease the energy flow between the battery and the DC link from a second power level to the target power level by controlling the drive circuit, based on the target level, the determined voltage of the DC link and the determined state of the battery, to cause the motor-generator to adjust the rotation speed of the flywheel such that the voltage of the DC link is changed to the target DC link voltage.

The present inventors have also devised, in accordance with a second example aspect herein, an electric vehicle comprising the hybrid energy storage system according to the first example aspect herein.

The present inventors have also devised, in accordance with a third example aspect herein, a computer-implemented method of generating control signals for controlling energy flow in a hybrid energy storage system. The hybrid energy storage system comprises a flywheel energy storage device having a flywheel, a motor-generator coupled to the flywheel, and a drive circuit arranged to drive the motor-generator. The hybrid energy storage system further comprises a battery coupled to the drive circuit via a DC link. The method comprises: acquiring a first indicator of a state of the battery; acquiring a first value of a voltage of the DC link; acquiring a second indicator indicating of a target power level of an energy flow between the battery and the DC link; acquiring a third indicator indicating a measured power level of the energy flow between the battery and the DC link; and comparing the target power level indicated by the second indicator with the measured power level indicated by the third indicator. The method further comprises: in case the target power level is greater than the measured power level, generating a control signal, based on the target power level, the first value of the voltage of the DC link and the first indicator of the state of the battery, for controlling the drive circuit to cause the motor-generator to adjust a rotation speed of the flywheel such that the voltage of the DC link is changed to a target DC link voltage that causes the energy flow between the battery and the DC link to increase to the target power level; and, in case the target power level is smaller than the measured power level, generating a control signal, based on the target power level, the first value of the voltage of the DC link and the first indicator of the state of the battery, for controlling the drive circuit to cause the motor-generator to adjust a rotation speed of the flywheel such that the voltage of the DC link is changed to a target DC link voltage that causes the energy flow between the battery and the DC link to decrease to the target power level.

The present inventors have further devised, in accordance with a fourth example aspect herein, a computer program which, when executed by a processor, causes the processor to perform the method according to the third example aspect herein.

The present inventors have further devised, in accordance with a fifth example aspect herein, a non-transitory computer-readable storage medium storing the computer program according to the fourth example aspect herein.

The present inventors have further devised, in accordance with a sixth example aspect herein, a hybrid energy storage system for powering a drive system of an electric vehicle. The hybrid energy storage system comprises a flywheel energy storage device having: a flywheel; a motor-generator coupled to the flywheel; and a drive circuit arranged to drive the motor-generator. The hybrid energy storage system further comprises a battery coupled to the drive circuit via a DC link, and a controller. The controller is operable in: a first mode to control an energy flow between the flywheel energy storage device and the DC link while preventing an energy flow between the battery and the DC link; and a second mode to control an energy flow between the flywheel energy storage device and the DC link, and a concurrent energy flow between the battery and the DC link.

### BRIEF DESCRIPTION OF THE DRAWINGS

Example embodiments herein will now be explained in detail, by way of non-limiting example only, with reference to the accompanying figures described below. Like reference numerals appearing in different figures can denote identical or functionally similar elements, unless indicated otherwise.

FIG. 1 is a schematic illustration of a hybrid energy storage system 100 according to a first example embodiment herein.

FIG. 2 is a schematic illustration of a variable frequency drive controller employed in the first example embodiment herein.

FIG. 3 is a schematic illustration of a hybrid energy storage system 200 according to a second example embodiment herein.

FIG. 4A is a schematic plot of a pulse width modulation (PWM) signal output by the pulse width modulator 145 of the second example embodiment, and a schematic plot of a current consequently induced in a stator winding of the motor-generator of the second example embodiment.

FIG. 4B is a schematic plot of a modified PWM signal generated by pulse truncation, and a schematic plot of a current consequently induced in the stator winding of the motor-generator of the second example embodiment.

FIG. 4C is a schematic phasor diagram illustrating the vectoral impact of the retardation of the PWM signal by pulse truncation shown in FIG. 4B.

FIG. 5 is a schematic illustration of a programmable signal processing hardware, which may be configured to perform the functions of the controller and/or the battery state sensor described herein.

FIGS. 6A and 6B are a flow diagram illustrating a computer-implemented method of generating control signals for controlling energy flow in a hybrid energy storage system, which is in accordance with an example embodiment.

FIG. 7 is a flow diagram illustrating an example of a process by which the control signals may be generated in the example embodiment using a data array described herein.

FIG. 8 is a flow diagram illustrating a computer-implemented method of determining a first battery state parameter, which is employed in the example embodiment.

FIG. 9 is a flow diagram illustrating a computer-implemented method of determining a secondary battery state parameter, which is employed in the example embodiment.

FIG. 10 is a flow diagram illustrating a computer-implemented method of operating a hybrid energy storage system in advance of a predicted event, which is employed in the example embodiment.

### DETAILED DESCRIPTION OF EMBODIMENTS

The present inventors have recognised that some of drawbacks of hybrid energy storage systems proposed or used in the automotive field, as described above, can at least partially be overcome by departing from the conventional approach of using a battery as a primary energy store and a flywheel, supercapacitor or other type of energy store as a secondary energy store, and instead using a flywheel as the primary energy store in the hybrid energy storage system, with one or more batteries functioning as a secondary energy store. That is, in embodiments described herein, the battery acts in a supporting role to the flywheel and either delivers/absorbs no power (leaving the flywheel to meet the energy demands of a load connected to the hybrid energy storage system) or merely supplements the flywheel's delivery/absorption of power to/from the load, when required.

When the battery is configured as a secondary energy store, its usage can advantageously be constrained to operating conditions that allow the battery's service lifetime to be increased, for example. In this regard, the frequency of micro-cycling of the battery, particularly when the hybrid energy storage system is used in an electric vehicle that stops frequently (e.g. in an urban environment), can be reduced (or the micro-cycling can, in some circumstances, be avoided altogether) by employing an arrangement where the flywheel acts as the primary energy store, providing and absorbing energy during the short periods of acceleration and regenerative breaking that frequently occur as the load on the hybrid energy storage system varies over time. This arrangement may (to at least some extent) shield the battery from the varying load requirements and thus reduce fluctuations in the battery's state of charge, and thereby delay the onset of battery degradation and increase the lifetime of the battery. Usage of the battery can instead be reserved for instances where the operating conditions are favourable, such as during periods of steady, moderate power flow to the load (e.g. when the electric vehicle is travelling at a largely constant speed). The battery may also be protected from the high thermal loads associated with repeated charge/discharge cycles during frequent acceleration and regenerative braking, resulting in decreased battery cooling requirements.

This arrangement is particularly useful for electric buses, especially in urban environments. Electric buses generally travel along predetermined routes between bus stops, each of which may incorporate a charging point. Due to the frequency and duration of the stops, the flywheel can be regularly recharged, further reducing the usage of the battery and so increasing the distance which the bus can travel.

Example embodiments of a hybrid energy storage system with a flywheel as the primary energy storage and at least one battery as a secondary energy storage will now be described in detail with reference to the accompanying drawings.

### First Example Embodiment

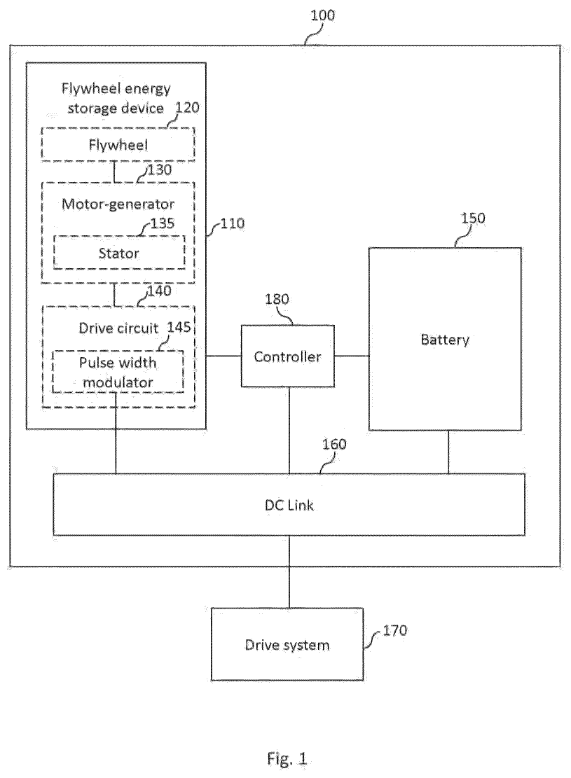

FIG. 1 is a schematic illustration of a hybrid energy storage system 100 according to a first example embodiment, which uses a flywheel energy storage device 110 as a primary energy store, and a battery 150 as a secondary energy store. The battery 150 is coupled to the flywheel energy storage device 110 via a DC link 160. The hybrid energy storage system 100 is configured to power a drive system 170 of an electric vehicle (not shown) via the DC link 160, allowing the drive system 170 to propel the electric vehicle.

The flywheel energy storage device 110 comprises a flywheel 120, a motor-generator 130 and a drive circuit 140. The flywheel 120 and the motor-generator 130 may collectively be referred to an “accumulator-motor-generator” (AMG). The motor-generator 130 may have a drive shaft that is mechanically coupled by any known means (which may include a gear mechanism with a fixed or variable gear ratio) to a drive shaft or other component of the flywheel 120 so to be capable of spinning (and being spun by) the flywheel 120. The motor-generator 130 may be controlled to convert kinetic energy stored in the flywheel 120 into electrical energy, which it can transfer to the DC link 160. The flywheel energy storage device 110 can thus provide electrical energy from the flywheel 120 to any component connected to the DC link 160. The motor-generator 130 may also be controlled during operation of the hybrid energy storage system 100 to use electrical energy from the DC link 160 to accelerate the flywheel 120. The form of the flywheel 120 is not limited and may be of any suitable type, such as a rimmed, shaftless or superflywheel, and may have a fixed or a variable moment of inertia. In electric vehicle applications of the hybrid energy storage system 100, the flywheel 120 would typically maintain a rotational speed of above 20,000 rpm, although the flywheel's rotational speed may be different in other applications.

The motor-generator 130 may thus be controlled to convert the kinetic energy of the flywheel 120 into electrical energy to provide to the DC link 160, or conversely to convert electrical energy from the DC link 160 to kinetic energy of the flywheel 120. The motor-generator 130 may comprise a single unit (dynamotor) that is capable of functioning as both a motor and generator, and which has coils (which may, in some cases, comprise separate motor coils and generator coils) wound around a common rotor. However, the motor-generator 130 may instead comprise a dedicated motor unit and a separate, dedicated electrical generator that are connected to each other. When the kinetic energy of the flywheel 120 is being converted into electrical energy, the motor-generator 130 acts as a generator driven by the flywheel 120 (as a prime mover). When electrical energy is being converted into kinetic energy of the flywheel 120, the motor-generator 130 acts as a motor, with the flywheel 120 as its load.

The motor-generator 130 may, as in the present example embodiment, be an AC induction motor-generator. That is, when the motor-generator 130 converts kinetic energy of the flywheel 120 into electrical energy, the motor-generator 130 functions as an induction generator and produces an AC current. On the other hand, when the motor-generator 130 converts electrical energy into kinetic energy of the flywheel 120, the motor-generator 130 functions as an induction (asynchronous) motor. However, the motor-generator 130 may alternatively be any other type of AC motor-generator, such as a synchronous motor-generator, which comprises an arrangement that functions as both an alternator and a synchronous motor. The motor-generator 130 may alternatively be any type of DC motor-generator which can produce/use a DC current, such as by acting as both a dynamo and a DC motor (i.e. a brushed, brushless or un-commutated DC motor).

The motor-generator 130 may, as in the present example embodiment, comprise a stator 135, which encloses a rotor (not shown) attached to the flywheel 120. The stator 135 may comprise at least one pair of coils (electromagnets) capable of producing a magnetic field when an AC current flows through them. The number of pairs of coils may determine the number of phases of the system (e.g. 3 pairs of coils are usually used to provide a 3-phase system). The one or more pairs of coils can generate a rotating magnetic field in response to an applied current passing through the coils. The stator 135 may be used both in example embodiments comprising a synchronous motor-generator and those comprising an asynchronous motor-generator, and its form may be adapted to the type of rotor used. As would be appreciated by those skilled in the art, the stator 135 may alternatively be arranged for use in a DC motor-generator, where the motor-generator 130 takes this form.

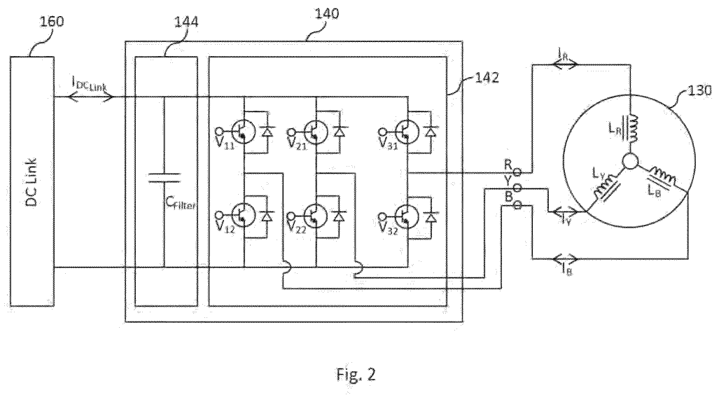

The drive circuit 140 is arranged to drive the motor-generator 130. The drive circuit 140 of the present example embodiment is a variable-frequency controller that is arranged to output an alternating voltage which generates magnetic fields in the stator 135 that pass through the rotor. A schematic illustration of the variable frequency controller of the present example embodiment is shown in FIG. 2. This variable frequency controller comprises an inverter 142 connected to a filter circuit 144. The filter circuit 144 is connected to the DC link 160, and the inverter 142 is connected to the respective stator coils of the motor-generator 130. The inverter 142 converts the DC voltage of the DC link 160 to AC voltage for the motor-generator 130. The filter circuit 144 between the DC link 160 and inverter 142 can selectively filter DC components from the electrical signal, or select AC components, in order to improve the quality of the electrical signal.

Referring again to FIG. 1, the drive circuit 140 may, as in the present example embodiment, further comprise a pulse width modulator 145, which is arranged to generate a pulse width modulation (PWM) signal that is input to the inverter to set the frequency of the alternating voltage which the inverter produces. The frequency of the alternating voltage sets the frequency of the rotating magnetic field in the stator 135. The rotational frequency of the stator 135 can be set relative to that of the rotor such that the motor-generator 130 acts as an induction motor or as an induction generator.

However, the drive circuit 140 may be adapted for use with another AC motor-generator arrangement or in a DC motor-generator arrangement, which may be employed in an alternative embodiment. In the case of a DC motor-generator, for example, the drive circuit may not be not be a variable-frequency controller, and may instead comprise circuitry (e.g. H bridge circuit, which may be paired with PWD control, for example, or a circuitry which controls a variable resistor connected in series with the field coil or armature) for controlling the DC motor-generator to vary the rotational speed of the flywheel.

The DC link 160 provides an electrical connection between components in the hybrid energy storage system 100. The DC link 160 may comprise a DC link capacitor arranged to provide low-pass filtering and/or a bulk series inductance. Such an inductance, which may be comprised of parasitic inductances of capacitors and interconnecting conductors (e.g. cables, bus-bars) may mitigate high-frequency radiated electromagnetic energy components. The addition of a bulk inductance may be advantageous in some embodiments, as its presence may slow the response of the battery 150, allowing more time to control the AMG(s) to achieve the required DC link target voltage level.

The battery 150 may, as in the present example embodiment, comprise multiple electrochemical cells, which may be connected together in any suitable arrangement. The battery 150 may, however, alternatively have a single cell. The battery 150 may, as in the present example embodiment, be a lithium-ion battery, which is commonly used in electric vehicle applications owing to its relatively high energy density. However, any suitable battery could alternatively be used, such as a nickel metal hydride or sodium nickel chloride battery, for example. The battery 150 may be a so-called ‘smart battery,’ which has a so-called ‘battery management system’ (a type of electronic system) having the capability to determine, and report to an external data processing device, battery parameters such as the battery's voltage, output current, impedance, power output or state-of-charge (SoC), state-of-health (SoH), and so on.

The drive system 170 is the prime mover of the electric vehicle and uses electrical energy from the DC link 160 to propel the electric vehicle. The drive system 170 may comprise one or more electric motors, a transmission system configured to deliver power from the one or more electric motors to at least some of the vehicle's wheels, propeller or other means of propulsion, and a drive controller configured to control the motor(s) and, in some cases, also the transmission system.

The controller 180 is operable in a first mode to control an energy flow between the flywheel energy storage device 110 and the DC link 160 while preventing an energy flow between the battery 150 and the DC link 160. The controller 180 is also operable in a second mode to control an energy flow between the flywheel energy storage device 110 and the DC link 160, and a concurrent energy flow between the battery 150 and the DC link 160. The controller operates in the first mode of operation to transfer energy to/from the flywheel energy storage device 110 when power is not required to be drawn from or delivered to the battery 150. Hence, in this mode of operation, the flywheel energy storage device 110 acts as the sole energy store for exchanging energy with drive system 170, without any power being provided to/from the battery 150. The second mode of operation corresponds to a concurrent use of the flywheel energy storage device 110 and the battery 150 when energy is required to be exchanged with both these components. Thus, the flywheel energy storage device 110 functions as the primary energy store in the hybrid energy storage system 100, and the battery 150 acts as the secondary energy source, the battery 150 either providing no power to the drive system 170 (in the first mode), or supplementing the delivery/absorption of power to/from the drive system 170 by the flywheel energy storage device 110 (in the second mode).

The controller 180 may also be operable to control an energy flow between the battery 150 and the DC link 160 while preventing an energy flow between the flywheel energy storage device 110 and the DC link 160. This further mode of operation may be used when the flywheel energy storage device 110 reaches a prescribed maximum energy storage level and is not permitted to accept more power from the DC link 160, or when the flywheel energy storage device 110 reaches a prescribed minimum energy storage level and is not permitted to provide more power to the DC link 160, for example.

The controller 180 may, in accordance with the operational modes described above, control the drive circuit 140, as well as power electronics which are provided as an interface to the battery 150 (i.e. a battery interface module (BIM) or the like), and which regulate the flow of energy to/from the battery 150 by effectively varying the battery's voltage and/or internal impedance.

The controller 180 may switch between operation in the first and second modes based on a state of the hybrid energy storage system 100 and a state of the drive system 170 of the electric vehicle, for example. The state of the hybrid energy storage system 100 may indicate the state of the flywheel energy storage device 110 (including the energy stored in the flywheel 120, for example) and the state of the battery (e.g. parameters indicative of the state of charge (SoC) of battery 150, and the maximum allowable charge/discharge rates). The state of the drive system 170 of the electric vehicle may be indicative of a required torque, a power output and/or a level of regenerative power of the drive system 170. For example, when, during operation of the controller 180 in the second mode, the drive system 170 requires power which would require a predetermined maximum discharge rate of the battery 150 to be exceeded, the controller 180 may switch to operating in the first mode to power the drive system 170 only from the flywheel energy storage device 110. Alternatively, when, during operation of the controller 180 in the first mode, the flywheel energy storage device 100 energy level is powering the drive system 170 and its energy storage level is approaching a prescribed lower limit or, in the case regenerative braking, the energy storage level of the flywheel energy storage device 100 is approaching a prescribed upper limit (e.g. an upper Safe Operating Area Rating), the controller 180 may switch to operating in the second mode such that the battery 150 can be discharged or charged, respectively, to avoid the aforementioned limits being exceeded.

The hybrid energy storage system 100 may be configured to use the flywheel 110 as the primary energy store and the battery 150 as a second energy store solely by control of the drive circuit 140, in an arrangement as described below in relation to the second example embodiment, wherein the BIM of battery 150 (or similar power electronics for regulating energy flow to/from the battery 150) is dispensed with, and the one or more cells of the battery 150 are coupled to the DC link 160 only by one or more passive electrical components that are incapable of controlling power flow between the battery 150 and the DC link 160. In this case, there is no direct control applied to the battery 150, which responds to changes in voltage of the DC link 160 according to its prevailing conditions and characteristics. Instead, all control is exerted by manipulating the DC link voltage via the drive circuit 140, which causes the flywheel 120 to speed up or slow down.

Although the flywheel energy storage device 110 may, as in the present example embodiment, comprise a single flywheel 120, motor-generator 130 and drive circuit 140, it should be noted that the flywheel energy storage device 110 may comprise more than one flywheel, motor-generator and/or drive circuit. Dividing the energy storage capacity of the flywheel energy storage device 110 between multiple flywheels may provide numerous advantages. In terms of safety, the amount of energy that must be dissipated or contained in the event of a catastrophic failure can be split across a plurality of flywheels so the weight and dimensions of containment means (provided for safety) can be reduced. Using a plurality of flywheels may also permit greater flexibility with regard to positioning the flywheel energy storage device 110 in an electric vehicle, which may advantageously facilitate achieving a desired weight distribution. Further, using a plurality of flywheels increases the degree of redundancy of the flywheel energy storage device 110, as a failure of a flywheel would only partially reduce the energy storage capacity of the flywheel energy storage device 110.

As an example, the flywheel energy storage device 110 may comprise two or more pairs of counter-rotating flywheels, and a respective motor-generator arranged to drive each flywheel in each of the pairs of the counter-rotating flywheels. Each counter-rotating flywheel pair may be driven by a single drive circuit 140 by connecting the motor-generators to the drive circuit 140 with differing phase sequences such that the motor-generators spin at opposing directions. For example, in the example of FIG. 2, a first motor-generator may be connected to the drive circuit 140 with a R-Y-B wiring as shown, and a second motor-generator may be connected by using a R-B-Y wiring to stator windings in the second motor-generator that correspond to those in the first motor-generator. Pairing the flywheels into counter-rotating pairs in this way may reduce or eliminate the gyroscopic reaction (Coriolis) torque that would otherwise arise, and thus improve an electric vehicle's handling characteristics and safety.

The hybrid energy storage system 100 of FIG. 1 may, as in the present example embodiment, be used to power the drive system 170 of an electric vehicle. The electric vehicle may be land-based (e.g. an electric car, truck, lorry or train), water-based (e.g. an electric boat, such as a river taxi) or an aircraft (e.g. an electric glider). The hybrid energy storage system 100 may alternatively be used to power a drive system for any other electric motorised system, such as an electric crane, whose typical energy usage pattern would cause micro-cycling of a battery supplying the system with power, and thus degrade the battery's performance (for example, its capacity and/or time/power required for charging) over time. The use of a flywheel 120 as a primary energy store in the hybrid energy storage system 100, whilst the battery 150 provides a secondary energy store, may allow the hybrid energy storage system 100 to supply loads with such energy usage patterns whilst avoiding at least some of the drawbacks of conventional hybrid energy storage systems that employ a battery as a primary energy store.

### Second Example Embodiment

In view of the above-mentioned problems arising from the use of battery interface modules (BIMs) in hybrid energy storage systems that employ batteries, the present inventors have recognised that the functionality of a BIM in regulating energy flows to/from a battery can be ‘virtualised’ by controlling energy flows to/from the battery solely through the control of the flywheel energy storage device 110 of the hybrid energy storage system 100. Virtualising the BIM, by dispensing with the physical BIM and implementing its functionality instead through a modified control of the drive circuit 140, may allow a weight saving to be achieved, and the size of the hybrid energy storage system to be reduced. Where the hybrid energy storage system is used in an electric vehicle, this reduction in weight and size may increase its range and carrying capacity. Further, the removal of the BIM hardware may also improve the reliability of the hybrid energy storage system, due to the lower component count. Furthermore, as BIMs tend to have a conversion efficiency of approximately 97% to 98% (lower in some circumstances), the associated energy losses can be significant, particularly when bi-directional conversion is required as part of a pre-defined control strategy, and the energy conversion efficiency of the battery 150 is also taken into account. A hybrid energy storage system having a ‘virtualised BIM’ instead of a physical BIM (or other power electronics that provide similar functionality), in accordance with the second example embodiment described below, may thus have greater energy efficiency than a conventional hybrid energy storage system having a physical BIM or the like.

Where the hybrid energy storage system is used in an electric bus, these improvements can be even more substantial, as BIMs appropriate for use in battery-powered electric busses would be relatively large and heavy, owing to their need to handle large power transfers (typically hundreds of kW).

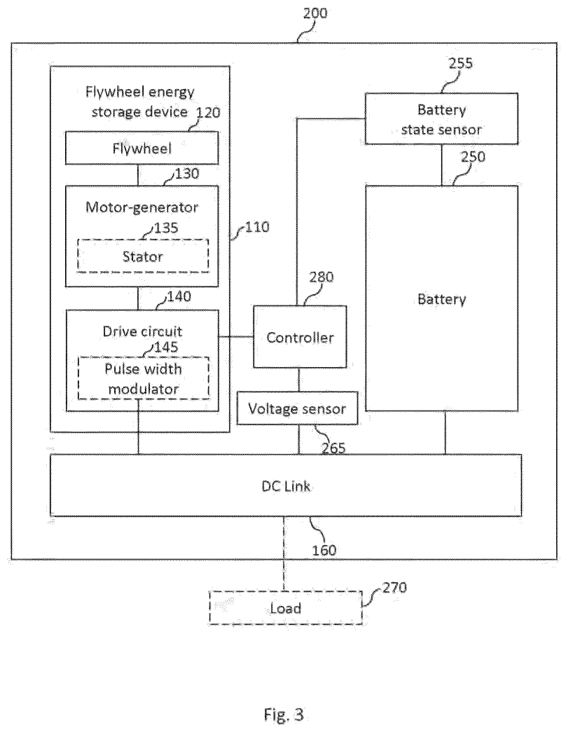

A second example embodiment of a hybrid energy storage system, which has a virtualised BIM as described briefly above, will now be described in more detail with reference to the accompanying drawings. Elements in the drawings (such as in FIG. 3), which have the same reference numerals as those described above, are the same, and foregoing description of these elements will not be repeated.

FIG. 3 is a schematic illustration of a hybrid energy storage system 200 according to the second example embodiment, which has virtualised BIM functionality such that no physical BIM is required or present in the hybrid energy storage system 200. The elements of the flywheel energy storage device 110 and the DC link 160 are the same as those in FIG. 1 described above.

Battery 250 of the present example embodiment differs from battery 150 by having no battery interface module (or any equivalent circuitry for controlling power delivered to/by the battery 250), either as a part of the battery 250 or as a separate component connected between the DC link 160 and one or both terminals of the battery 250. The one or more terminals of the battery 250 are coupled to the DC link 160 only by one or more passive electrical components (which may, in some embodiments, consist of electrical wiring) which is/are incapable of being controlled so as to vary a power flow between the battery 150 and the DC link 160.

The hybrid energy storage system 200 comprises a battery state sensor 255, and a voltage sensor 265, which are communicatively coupled to a controller 280 that is also included in the hybrid energy storage system 200.

The battery state sensor 255 is arranged to acquire a state of the battery 250. The state of the battery may, as in the present example embodiment, comprise a first battery state parameter which is indicative of an open-circuit voltage of the battery 250, and a second battery state parameter which is indicative of an impedance (internal resistance) of the battery 250. However, the battery state sensor 255 may more generally be arranged to acquire one or more parameters that are indicative of a state-of-health (SoH) of the battery 250, for example based on one or more of the following parameters (in some embodiments, a weighted combination of at least some of these parameters): the first battery state parameter, the second batter state parameter, the battery capacity, number of charge-discharge cycles performed by the battery, the age of the battery, the batter's self-discharge, total energy charged and discharged, and a temperature of the battery measured during prior operation. The battery state sensor 255 may also determine the current flow and/or power level of the energy flow between the battery 250 and DC link 160. The battery state sensor 255 may be implemented using well-known measurement and data processing circuitry for determining the aforementioned parameter(s), and the circuity may be provided separately from (but connected to) the battery 250, or it may be integrated with the battery 250 (as a battery management system of the battery, in the case of the so-called ‘smart battery’). Further, the battery state sensor 255 may acquire the state of the battery 250 by receiving some/all of battery state parameters as reported by a smart battery.

The voltage sensor 265 comprises a circuit connected to the DC link 160, which is arranged, in accordance with well-known techniques, to determine the voltage of the DC link 160.

The controller 280 is capable of increasing an energy flow between the battery 250 and the DC link 160 from a first power level to a target power level by controlling the drive circuit 140, based on the target power level, the voltage of the DC link determined by the voltage sensor 265 and the state of the battery 250 determined by the battery state sensor 255 (as described in more detail below), to cause the motor-generator 130 to adjust a rotation speed of the flywheel 120 such that the voltage of the DC link 160 is changed to a target DC link voltage that causes the energy flow between the battery 250 and the DC link 160 to be at the target power level. In other words, the controller 280 is arranged to send a control signal to the drive circuit 140, directing the drive circuit 140 to vary the rotational speed (angular velocity) of the rotor (by varying the excitation frequency of the stator 135) such that the rotational speed of the flywheel 120 coupled thereto also changes. This causes a change in the voltage of the DC link 160 until it reaches the target DC link voltage, which is calculated based on the target power level, the determined voltage of the DC link 160 and the determined state of the battery 250. When the target DC link voltage is reached, the energy flow between the battery 250 and the DC link 160 reaches the target power level. The rate of change of the rotational speed determines the target power level injected/absorbed to/by the DC link 160.

The controller 280 is further capable of decreasing the energy flow between the battery 250 and the DC link from a second power level to the target power level by controlling the drive circuit 140, based on the target level, the determined voltage of the DC link and the determined state of the battery 250 (as described in more detail below), to cause the motor-generator 130 to adjust the rotation speed of the flywheel 120 such that the voltage of the DC link 160 is changed to the target DC link voltage. In other words, the controller is arranged to send a control signal to the drive circuit 140, directing the drive circuit 140 to vary the rotational speed of the rotor (by varying the excitation frequency of the stator 135) such that the rotational speed of the flywheel 120 coupled thereto also changes. This causes a change in the voltage of the DC link 160 until it reaches the target DC link voltage, which is calculated based on the target power level, the determined voltage of the DC link and the determined state of the battery 250. When the target DC link voltage is reached, the energy flow between the battery 250 and the DC link 160 reaches the target power level.

The controller 280 is further capable of maintaining the energy flow between the battery 250 and the DC link at the target power level by controlling the drive circuit 140, based on the target power level, the determined voltage of the DC link 140 and the determined state of the battery 250 (as described in more detail below), to cause the motor-generator 130 to regulate the rotation speed of the flywheel 120 such that the voltage of the DC link 160 is maintained at the target DC link voltage. In other words, the controller is arranged to send a control signal to the drive circuit 140, directing the drive circuit 140 to vary the rotational speed of the rotor (by varying the excitation frequency of the stator 135) such that the rotational speed of the flywheel 120 changes in order to keep the voltage of the DC link 160 at the target DC link voltage. By the rotational speed of the flywheel 120 thus being regulated to maintain the target DC link voltage, the energy flow between the battery 250 and the DC link 160 can be maintained at the target power level.

The load 270 is connected to the DC link 160 so as to be capable of exchanging energy with the DC link 160. The load 270 may, as in the present example embodiment, comprise the drive system 170 of an electric vehicle (as in the example embodiment of FIG. 1). However, the load 270 is not so limited, and may take one of various other forms, for example an electric motorised system such as a drive system for an electric crane, as noted above. The hybrid energy storage system 200 of the present example embodiment is operable to power one or more electric motors of an electric vehicle to propel the electric vehicle.

During operation of the hybrid energy storage system 200, the motor-generator 130 is arranged to spin within a range of angular velocities that allow the flywheel 120 to exchange energy with the DC link 160 on a smaller timescale than the battery 250, thus allowing the flywheel energy storage device 110 to mitigate or otherwise react to changes in the voltage of the DC link 160 (caused by the load 270) ahead of the battery 250. During operation of the hybrid energy storage system 200, the motor-generator 130 may be arranged to spin within a range of angular velocities such that, in response to a change in the voltage of the DC link 160 caused by the load 270 when connected to the DC link 160, the controller 280 is arranged to control the drive circuit 140 (based on the target power level, the determined monitored voltage of the DC link 160 and the determined monitored state of the battery 250, as noted above) to cause the motor-generator 130 to accelerate or decelerate such that a change in power of the energy flow between the flywheel 120 and the DC link 160 is greater (by any amount, but preferably by at least an order of magnitude, for example) than a change in power of the energy flow between the battery 250 and the DC link 160 in response to the change in the voltage of the DC link 160. Additionally or alternatively, the range of angular velocities at which the motor-generator 130 rotates may be such that a change in energy flow between the flywheel 120 and the DC link 160 occurs on a first timescale which is smaller (by any amount, but preferably by at least an order of magnitude, for example) than a second timescale, the second timescale being a shortest timescale over which a flow of energy between the battery 250 and the DC link 160 can change in response to the change (or any other change) in the voltage of the DC link 160.

The aforementioned functionality of the controller 280 may allow the flywheel energy storage device 110 to respond to changes in the voltage of the DC link 160 that occur over a first minimum time period, which may, by way of an example, be approximately 100 ms in the present embodiment. The response of the flywheel energy storage device 110 to these changes in the voltage of the DC link 160 may involve substantial energy transfers, which may be 50 Wh or greater. However, the flywheel energy storage device 110 may, as in the present example embodiment, also be controlled by the controller 280 to respond to changes in the DC link voltage which occur on timescales that may be three (or more) orders of magnitude smaller than the aforementioned minimum time period (e.g. around 50 μs).

This may be achieved by the controller 280 being further arranged to introduce a phase shift into the alternating voltage output from drive circuit 140, by varying the PWM signal generated by the pulse width modulator 145, based on a difference between the determined monitored voltage of the DC link 160 and the target DC link voltage, such that energy is transferred between the stator 135 and the DC link 160 to reduce the difference between the determined monitored voltage of the DC link 160 and the target DC link voltage. The controller 280 may modify the PWM signal in any suitable way. By way of an example, the variation in the PWM signal may, as in the present example embodiment, be achieved by the controller 280 adjusting a width of at least one pulse in the PWM signal based on the difference between the determined voltage of the DC link 160 and the target DC link voltage. Alternatively, the variation in the PWM signal may be achieved by the controller 280 removing at least one pulse in the PWM signal or inserting at least one additional pulse to the PWM signal, based on the difference between the determined voltage of the DC link 160 and the target DC link voltage. When the controller 280 modifies the PWM signal (e.g. by adjusting at least one pulse width, removing at least one pulse or inserting at least one additional pulse), it may vary the PWM signal using the above-described techniques, without modifying the duration (or presence) of subsequent pulses in the PWM signal.

The controller 280 may adjust width of the at least one pulse of the PWM signal, based on the difference between the determined voltage of the DC link 160 and the target DC link voltage, in different ways.

In case the determined monitored voltage of the DC link 160 is greater than the target DC link voltage by at least a first predetermined amount, the controller 280 may be arranged to increase the width of the one or more pulses of the PWM signal by an amount dependent on the difference such that energy is transferred from DC link 160 to the stator 135 to reduce the difference. Thus, one or more pulses of the PWM signal have their width increased by the action of the controller 280, which advances the phase of the alternating voltage, and causes the stator 135 to draw energy from the DC link 160, reducing the voltage of the DC link 160.

In case the determined monitored voltage of the DC link 160 is less than the target DC link voltage by at least a second predetermined amount, the controller 280 is arranged to decrease the width of the one or more pulses of the PWM signal by an amount dependent on the difference, such that energy is transferred from the stator 135 to the DC link 160 to reduce the difference. Thus, one or more pulses of the PWM signal have their width decreased by the action of the controller 280, which retards the phase of the alternating voltage, and causes the stator 135 to transfer energy to the DC link 160, increasing the voltage of the DC link 160.

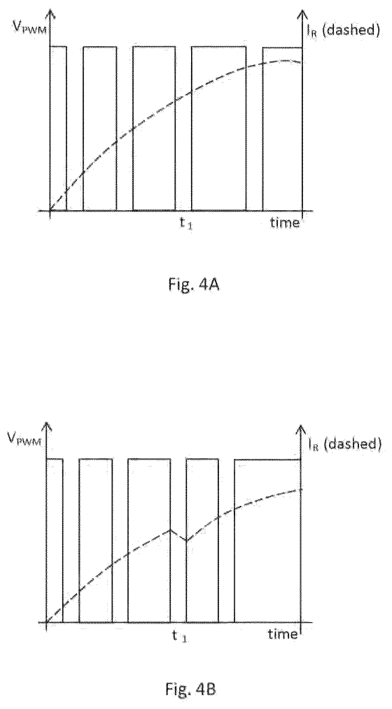

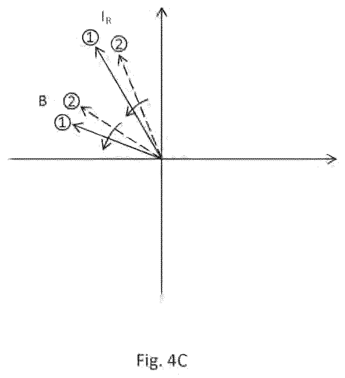

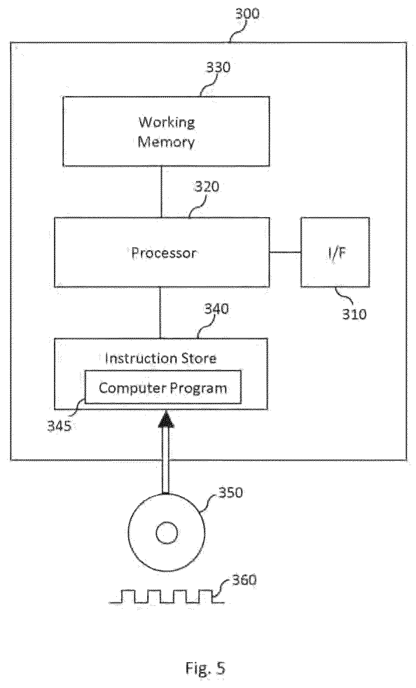

An explanation of how the controller 280 may introduce a phase shift into the alternating voltage output from drive circuit 140, in the case that the determined voltage of the DC link 160 is less than the target DC link voltage, will now be provided with reference to FIGS. 4A, 4B and 4C.

FIG. 4A shows the PWM signal output by the pulse width modulator 145 during normal operation of motor-generator 135 at a first frequency. The variation over time of the current induced in stator winding R in FIG. 2 by the alternating voltage output from the drive circuit 140 is shown by the dashed line in FIG. 4A, and the current is represented in the phasor diagram of FIG. 4C by the “I_{R}” vector. This stator winding, in combination with the other Y and B stator windings in FIG. 2 (not shown in FIG. 4C), sets up a rotating magnetic field B in the stator 135 of the motor-generator 130, shown as the “B” vector in the phasor diagram of FIG. 4C.

Upon determining that the determined monitored voltage of the DC link 160 is less than the target DC link voltage, the controller 280 decreases the width of a pulse in the PWM signal of the pulse-width modulator 145. An example of the shortened pulse is illustrated in FIG. 4B, where this pulse is shown to start at time t₁. By decreasing the width of this pulse, the current induced in stator winding R in FIG. 2, as shown by the dashed line in FIG. 4B, has its phase retarded as energy is transferred from the stator 135 to the DC link 160. This is shown in FIG. 4C by the phase change of the “I_{R}” vector to the second I_{R} vector (illustrated using a dashed line) which, in combination with the other Y and B stator windings in FIG. 2, causes a corresponding phase change in the rotating magnetic field B in the stator 135 of the motor-generator 130 of the “B” vector (illustrated using a solid line in FIG. 4C) to the second “B” vector (illustrated using a dashed line in FIG. 4C). The magnitude of the first “I_{R}” and “B” vectors (illustrated using solid lines in FIG. 4C) are decreased (as illustrated by the lengths of the dashed lines in FIG. 4C, representing the second “I_{R}” and “B” vectors), as energy is transferred from the stator 135 to the DC link 160.

It should be noted that, when the determined monitored voltage of the DC link 160 is less than the target DC link voltage by at least the first predetermined amount, and is greater than the target DC link voltage by at least the second predetermined amount, then the controller does not introduce any phase shift into the alternating voltage (i.e., the controller performs neither of the previously described actions).

While the present example embodiment addresses problems associated with the use of a BIM in the first example embodiment, by ‘virtualising’ the functionality of the BIM, the controller 280 of the present example embodiment is (in common with the controller 180 of the first example embodiment) nevertheless operable in the first operational mode to control an energy flow between the flywheel energy storage device 110 and the DC link 160 while preventing an energy flow between the battery 250 and the DC link 160, and in the second operational mode to control an energy flow between the flywheel energy storage device 110 and the DC link 160, and a concurrent energy flow between the battery 250 and the DC link 160. The hybrid energy storage system 200 of FIG. 3 may thus provide the same benefits as the hybrid energy storage system 100 of FIG. 1, along with the additional benefits associated with the virtualisation of the BIM.

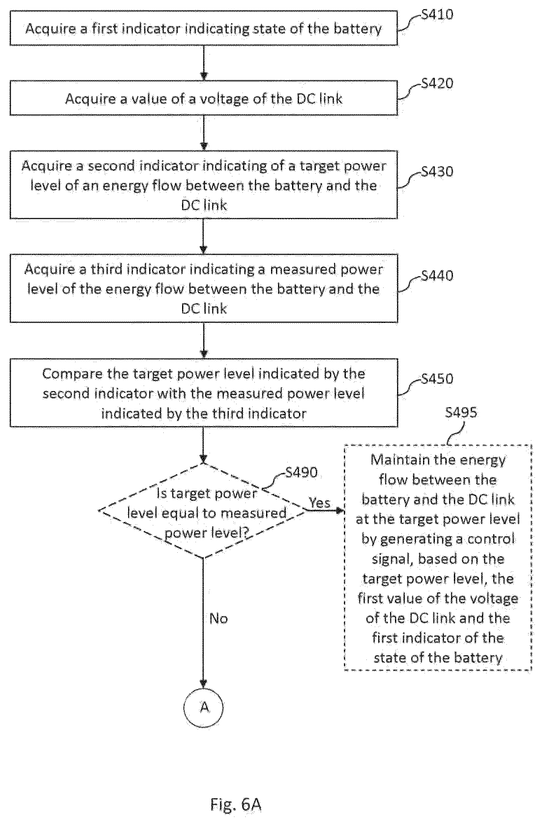

Both controller 180 of FIG. 1 and controller 280 of FIG. 3 may be provided in any suitable form, for example as a programmable signal processing hardware 300 of the kind illustrated schematically in FIG. 5. The battery state sensor 255 may also be provided in the form of the programming signal processing hardware 300. However, the battery state sensor 255 may alternatively be a separate component, as previously described, or may be provided in distinct programmable signal processing hardware of the same kind as the programmable signal processing hardware 300.

The programmable signal processing apparatus 300 comprises a communication interface (I/F) 310, for receiving input information (such as the target power level, the determined voltage of the DC link and the determined state of the battery), and for outputting the control signals which control the energy flow between the flywheel energy storage device 110 and the DC link 160, and the battery 150/250 and the DC link 160. For the controller 180, the communication I/F 310 outputs the control signals to the appropriate components as previously described. For controller 280, the communication I/F 310 outputs the control signals to the drive circuit 140. For the battery state sensor 255, the communication I/F 310 may be connected to hardware capable of measuring the values necessary for determining the state of the battery, as described with reference to FIG. 3.

The signal processing hardware 300 further comprises a processor (e.g. a Central Processing Unit, CPU, and/or a Graphics Processing Unit, GPU) 320, a working memory 330 (e.g. a random access memory) and an instruction store 340 storing a computer program 345 comprising the computer-readable instructions which, when executed by the processor 320, cause the processor 320 to perform various functions including those of controller 180, controller 280 and/or battery state sensor 255 described herein (i.e. one or more of the computer-implemented methods described herein below). The working memory 330 stores information used by the processor 320 during execution of the computer program 345. The instruction store 340 may comprise a ROM (e.g. in the form of an electrically erasable programmable read-only memory (EEPROM) or flash memory) which is pre-loaded with the computer-readable instructions. Alternatively, the instruction store 340 may comprise a RAM or similar type of memory, and the computer-readable instructions of the computer program 345 can be input thereto from a computer program product, such as a non-transitory, computer-readable storage medium 350 in the form of a CD-ROM, DVDROM, etc. or a computer-readable signal 360 carrying the computer-readable instructions. In any case, the computer program 345, when executed by the processor 220, causes the processor 320 to perform the functions of controller 180, controller 280 and/or battery state sensor 255 as described herein.

It should be noted, however, that the controller 180, controller 280 and/or battery state sensor 255 may alternatively be implemented in non-programmable hardware, such as an ASIC, an FPGA or other integrated circuit dedicated to performing the functions of the controller 180, controller 280 and/or battery state sensor 255 described above, or a combination of such non-programmable hardware and programmable hardware as described above with reference to FIG. 5.

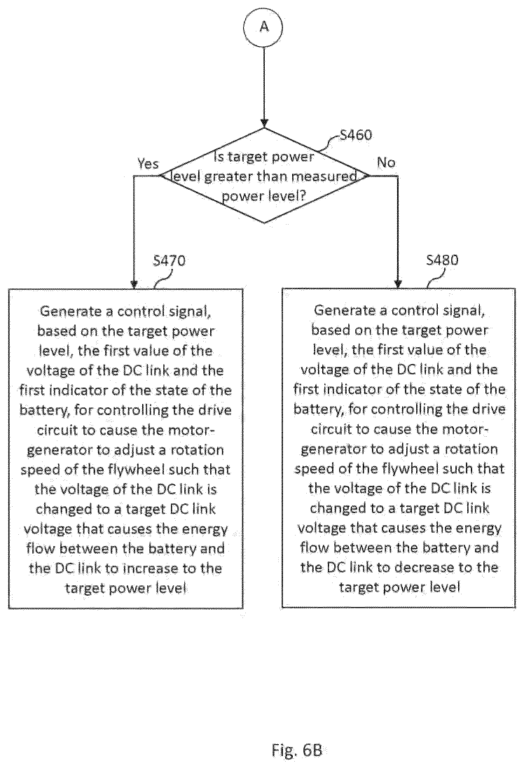

FIGS. 6A and 6B is a flow diagram illustrating a (computer-implemented) method by which processor 320 (performing the function of the controller 280 and the battery state sensor 255 of the example embodiment of FIG. 3) increases, decreases or maintains an energy flow between the battery and the DC link.

In S410 of FIG. 6A, the processor 320 acquires a first indicator of a state of the battery 280. The processor 320 may, as in the present example embodiment, acquire a first battery state parameter, which is indicative of an open-circuit voltage (or a float voltage) of the battery 250, and a second battery state parameter, which is indicative of an internal impedance of the battery 250. The open-circuit voltage at a given instant may vary depending upon the battery SoC, temperature, battery age and other factors. The processor 320 may receive first and second battery state parameters from the battery management system of the battery (in case the battery 250 is a smart battery), which can calculate the required battery parameters based on internal measurements within the battery, measurements of instantaneous battery current, battery temperature and other factors, using battery modelling methodologies which are widely established and used, as described in Liu, K., Li, K., Peng, Q. et al. “A brief review on key technologies in the battery management system of electric vehicles.” Front. Mech. Eng. 14, 47-64 (2019), the entire contents of which are incorporated herein by cross-reference.

In S420 of FIG. 6A, the processor 320 acquires a first value of a voltage of the DC link 160 from the voltage state sensor 265.

In S430 of FIG. 6A, the processor 320 acquires a second indicator indicating a target power level of an energy flow between the battery 250 and the DC link 160. The second indicator may be determined based on the requirements of the drive system 170 of the electric vehicle, such as a required torque and/or a required power output thereof, for example. The processor 320 may acquire the second indicator by receiving it from the drive system 170 of the electric vehicle. Alternatively, where the processor 320 also implements power management functions of the drive system 170, the processor 320 may acquire the second indicator by calculating it using well-known techniques, based on parameters such as the detected position of an accelerator pedal, detected speed and acceleration of the electric vehicle, etc.

In S440 of FIG. 6A, the processor 320 acquires a third indicator indicating a measured power level of the energy flow between the battery 250 and the DC link 160. This power level may be determined by direct measurement or calculated from measured values of the voltage across the battery 250 and the current flow from/into the battery 250, for example. Where the battery 250 is a smart battery having a battery management system or the like for reporting battery parameters including the battery's power output, the processor 320 may receive the third indicator from the battery management system of the battery 250 in S440 of FIG. 6A. In case of the battery 250 not being a smart battery having such functionality, the processor 320 may acquire the third indicator in S440 of FIG. 6A by calculating it based on received measured values of the voltage across the battery 250 and the current flow from/into the battery 250.

In S450 of FIG. 6A, the processor 320 compares the target power level indicated by the second indicator with the measured power level indicated by the third indicator.

In S490 of FIG. 6A, the processor 320 determines whether the target power level is equal to the measured power level. If the target power level is determined in S490 to be equal to the measured power level (to within a predefined margin of error), the method progresses to S495 of FIG. 6A, otherwise the method proceeds to S460 in FIG. 6B.

In S460 of FIG. 6B, the processor 320 determines whether the target power level is greater than the measured power level. In case the processor 320 determines that the target power level is greater than the measured power level in S460, then the method progresses to S470 in FIG. 6B, and otherwise proceeds to S480 in FIG. 6B.

In S470 of FIG. 6B, the processor 320 generates a control signal, based on the target power level, the first value of the voltage of the DC link 160 and the first indicator of the state of the battery 250, for controlling the drive circuit 140 to cause the motor-generator 130 to adjust a rotation speed of the flywheel 120 such that the voltage of the DC link 160 is changed to a target DC link voltage that causes the energy flow between the battery 250 and the DC link 160 to increase to the target power level. In other words, a control signal is sent to the drive circuit 140, causing it to vary the rotational speed of the stator 135 such that the rotational speed of the flywheel 120 changes. This causes the voltage of the DC link 160 to change until it reaches the target DC link voltage. When the DC link voltage reaches the target DC link voltage, the energy flow between the battery 250 and the DC link 160 reaches the target power level.

In S480 of FIG. 6B, the processor 320 generates a control signal, based on the target power level, the first value of the voltage of the DC link 160 and the first indicator of the state of the battery 250, for controlling the drive circuit 140 to cause the motor-generator 130 to adjust a rotation speed of the flywheel 120 such that the voltage of the DC link 160 is changed to a target DC link voltage that causes the energy flow between the battery 250 and the DC link 160 to decrease to the target power level. In other words, a control signal is sent to the drive circuit 140, causing it to vary the rotational speed of the stator 135 such that the rotational speed of the flywheel 120 changes. This causes the voltage of the DC link 160 to change until it reaches the target DC link voltage. When the DC link voltage reaches the target DC link voltage, the energy flow between the battery 250 and the DC link 160 reaches the target power level.

Referring again to FIG. 6A, in S495, the processor 320 generates a control signal, based on the target power level, the first value of the voltage of the DC link 160 and the first indicator of the state of the battery 250, for controlling the drive circuit 140 to cause the motor-generator 130 to regulate the rotation speed of the flywheel 120 such that the voltage of the DC link 160 is set to a target DC link voltage that causes the energy flow between the battery 250 and the DC link 160 to be maintained at the target power level.

It should be noted that S490 in FIG. 6A (and, therefore, S495 in FIG. 6A) are optional acts. In an example embodiment with S490 and S495 omitted, S460 may be replaced with a determination of whether the target power level is either greater or less than the measured power level. Where the target power level is determined to be greater than the measured power level, the method would progress to S470 in FIG. 6B and, where the target power level is determined to be less than the measured power level, the method would progress to S480 in FIG. 6B. In such a variant, the processor 320 takes no action until the target level changes to differ from the measured power level.

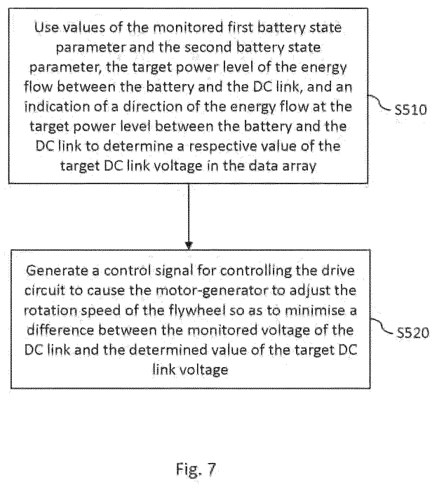

FIG. 7 is a flow diagram illustrating an example of a method by which processor 320 (performing the function of the controller 280 of the example embodiment of FIG. 3) controls the drive circuit 140 to cause the motor-generator 130 to adjust the rotation speed of the flywheel 120 such that the voltage of the DC link 160 is changed to the target DC link voltage. In other words, the method of FIG. 7 is an example of how the processor 320 generates the control signal in S470, S495 and S480 of FIGS. 6A and 6B.

In S510 of FIG. 7, the processor 320 uses values of the first battery state parameter and the second battery state parameter, the target power level of the energy flow between the battery 250 and the DC link 160, and an indication of a direction of the energy flow at the target power level between the battery 250 and the DC link 160 to determine a respective value of the target DC link voltage in a data array. In other words, the processor 320 uses the aforementioned values as inputs to look up a respective value of the target DC link voltage in the data array.

The data array (which may be provided in the form of a look-up table, for example) may be stored within the working memory 330 or instruction store 340 shown in FIG. 5, and is arranged to correlate different n-tuples with respective values of the target DC link voltage that cause the energy flow between the battery 250 and the DC link 160 to be at a respective power level, where each n-tuple comprises respective values of the first battery state parameter, the second battery state parameter, power level of the energy flow between the battery 250 and the DC link 160, and an indicator of a direction of the energy flow between the battery 250 and the DC link 160. In other words, the data array comprises of values of the target DC link voltage which correspond to a respective n-tuple of values. Therefore, the target DC link voltage can be chosen which corresponds to the n-tuple of values which match (or best fit) the input values to the data array. For batteries of the same, or generally similar, type, the data values in the data array may be normalised to permit adaptation to batteries of different voltage and kWh capacity.

In S520 of FIG. 7, the processor 320 generates a control signal for controlling the drive circuit 140 to cause the motor-generator 130 to adjust the rotation speed of the flywheel 120 so as to minimise a difference between the measured voltage of the DC link 160 and the determined value of the target DC link voltage (i.e. such that the voltage of the DC link 160 becomes equal to the determined value of the target DC link voltage or is within a predetermined margin of the determined value of the target DC link voltage). In other words, the processor 320 generates and sends a control signal to the drive circuit 140, causing it to vary the rotational speed of the rotor (by varying the excitation frequency of the stator 135), for example by using proportional-integral-derivative (PID) control techniques, such that the measured voltage of the DC link 160 becomes equal to, or comes within a predetermined margin of, the determined value of the target DC link voltage.

The processor 320 may compare the measured voltage of the DC link 160 with the determined value of the target DC link voltage in S520 of FIG. 7, with three outcomes being possible.

Firstly, the measured voltage of the DC link 160 may be equal to the target DC Link voltage (within an error of typically +/−2.5V per 100V of battery voltage, although other values may be appropriate, depending on the characteristics of the connected battery). In this case, the processor 320 may take no action, and the AMG speed remains at the prevailing level. Energy flows from the AMG to external systems are small.

Secondly, the measured voltage of the DC link 160 may be below the target DC Link voltage (and has exceeded the allowable error band). In this case, the AMG decelerates. The rate of deceleration, defined as the derivative of AMG angular velocity with respect to time, may be informed by the observed error between the measured voltage of the DC link 160 and the target DC Link voltage. An appropriate rate of deceleration may be set by the dimensions of the flywheel 120, the behaviour of the drive circuit 140 and the associated motor-generator 130 shown in FIG. 3 1 (particularly the efficiency performances) and other factors. A piecewise linear relationship between the rate of deceleration and the difference between the measured DC Link voltage and the target DC Link voltage (the “Error”) may be used to inform the control relationship between the Error and the deceleration rate. In operation, rate of deceleration may follow a proportional-integral-derivative profile, based on the observed Error. Energy can thus be recovered from the rotational inertia of the flywheel 120, and may flow from the AMG to load 270, tending to reduce the Error. The presence of an integral term in the control relationship may act to reduce stable errors over time. In some example embodiments, the Error may be reduced to within 1% of zero within 500 ms. The balance between the proportional, integral and derivative terms can be chosen based upon the characteristics and performances of the AMG and the ratings of the battery 250, with the attack rates of the drive system (as an example of the load 270), i.e. the rates of application of motive or regenerating power of which the drive is capable, also being considered. In some example embodiments, the derivative term will be small relative to the proportional and integral terms, and may be absent in some embodiments, acknowledging that rapid phenomena such as those that endure for 100 ms or less, may be of less significance than phenomena that persist for longer periods.

Thirdly, the measured voltage of the DC link 160 may be above the target DC Link voltage (and has exceeded the allowable error band). In this case, the AMG accelerates, and energy flows from load 270 to the AMG. In a fashion analogous to that described above, the rate of acceleration may follow a proportional-integral-derivative profile, based on the observed Error.

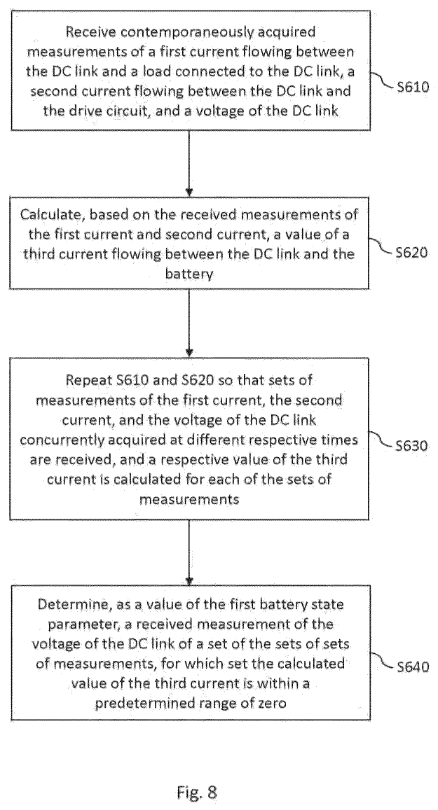

A technique of determining the first battery state parameter of the battery 250, which is applicable in the case where the battery 250 does not have a battery management system capable of reporting the first battery state parameter to the processor 320, will now be described with reference to FIG. 8. This technique makes use of any available current measurements from the drive system 170 and the drive circuit 140, which allow the battery current to be calculated using Kirchoff's Current Law applied to the DC Link node interconnecting the drive system 170, the drive circuit 140 and the battery 250. The described technique may allow the first battery state parameter to be determined even when the battery 250 does have a battery management system but this system has malfunctioned or failed.

FIG. 8 is a flow diagram illustrating an example of a method by which processor 320 (performing the function of the battery state sensor 255 of the example embodiment of FIG. 3) determines the first battery state parameter. In other words, FIG. 8 shows an example method by which processor 320 determines the first battery state parameter as the first indicator in S410 of FIG. 6A.

In S610 of FIG. 8, the processor 320 receives contemporaneously acquired measurements of a first current flowing between the DC link 160 and a load 270 connected to the DC link 160, a second current flowing between the DC link 160 and the drive circuit 140, and a voltage of the DC link 160. These current measurements are acquired ‘contemporaneously’ in the sense of being acquired simultaneously or within a time period which is small enough for the measured first and second current values to reflect respective values of the currents flowing at a common point in time, to within a prescribed degree of accuracy (e.g. 1%, 5% or 10%, for example). The voltage of the DC link 160 is acquired from the voltage sensor 265, as described with reference to FIG. 3.

In S620 of FIG. 8, the processor 320 calculates, based on the received measurements of the first current and second current, a value of a third current flowing between the DC link 160 and the battery 250. For example, the value of the third current may be calculated by applying Kirchhoff's current law to the received measurements.

In S630 of FIG. 8, the processor 320 repeats S610 and S620 so that sets of measurements of the first current, the second current, and the voltage of the DC link 160 concurrently acquired at different respective times are received, and a respective value of the third current is calculated for each of the sets of measurements. Thus, a set of the four parameters values, namely values of the first current, the second current, the third current and the voltage of the DC link 160, are generated for each of a plurality of different instances in time.

In S640 of FIG. 8, the processor 320 determines, as a value of the first battery state parameter, a received measurement of the voltage of the DC link 160 of a set of the sets of sets of measurements, for which set the calculated value of the third current is within a predetermined range of zero. In this process, a set of the four parameters wherein the third current is zero is identified and, in the identified set, the value of the first battery state parameter is set as the received measurement of the voltage of the DC link.

It should be noted that the processor 320 may repeatedly perform S610, S620, S630 and S640 in FIG. 8 so as to monitor the first battery state parameter.

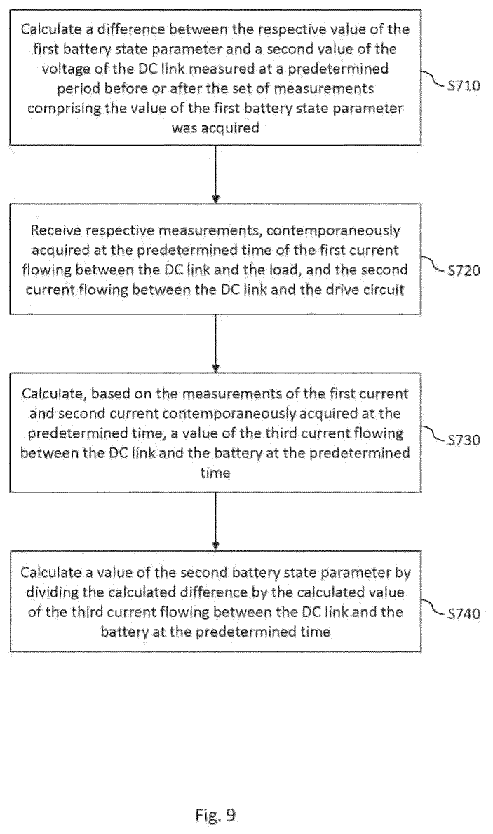

FIG. 9 is a flow diagram illustrating an example of a method by which processor 320 (performing the function of the battery state sensor 255 of the example embodiment of FIG. 3) may determine the secondary battery state parameter. In other words, FIG. 9 shows an example method by which processor 320 acquires the second battery state parameter as the first indicator following S640 in FIG. 8.

In S710 of FIG. 9, the processor 320 calculates a difference between the respective value of the first battery state parameter and a second value of the voltage of the DC link 160 measured at a predetermined time period before or after the set of measurements comprising the value of the first battery state parameter was acquired. The predetermined time period before or after the set of measurements may be the duration between two sets of the contemporaneously acquired measurements in S610 of FIG. 8 (i.e. the time between two of the instances in time in S630), or it may be the duration between a plurality of the sets. The second value of the voltage of the DC link 160 may be acquired from the voltage state sensor 265, as described with reference to FIG. 3.

In S720 of FIG. 9, the processor 320 receives respective measurements, contemporaneously acquired at the predetermined time period before or after the set of measurements comprising the value of the first battery state parameter was acquired, of the first current flowing between the DC link 160 and the load 270, and between the second current flowing between the DC link 160 and the drive circuit 140. The first and second currents may be acquired by receiving signals from ammeters connected in series between the DC link 160 and the load 270, and the DC link 160 and the drive circuit 140, respectively.

In S730 of FIG. 9, the processor 320 calculates, based on the contemporaneously acquired measurements of the first current and second current, a respective value of the third current flowing between the DC link 160 and the battery 250 at the predetermined time before or after the set of measurements comprising the value of the first battery state parameter was acquired. The value of the third current may be calculated using Kirchhoff's current law.

In S740 of FIG. 9, the processor 320 calculates a respective value of the second battery state parameter by dividing the calculated difference (in S710) by the respective value of the third current flowing between the DC link 160 and the battery 250 at the predetermined time before or after the set of measurements comprising the value of the first battery state parameter was acquired. In other words, the difference calculated in S710 of FIG. 9 is divided by the respective value of the third current calculated in S730 of FIG. 9 to give the respective value of the second battery state parameter.

In case the processor 320 repeatedly performs S610, S620, S630 and S640 of FIG. 8 so as to monitor the first battery state parameter, the method of FIG. 9 may likewise be performed in response to at least some of the determinations of the value of the first battery state parameter made in the performances of S640 of FIG. 8.

The method of the determining the first and second battery state parameters in FIG. 8 and FIG. 9, respectively, may only need to be repeated at intervals of approximately 1 minute as, under most normal operating conditions (e.g. a battery load of up to 0.2 times the battery capacity and a battery SoC within the range of 30 % to 80 %), these battery state parameters remain roughly constant.

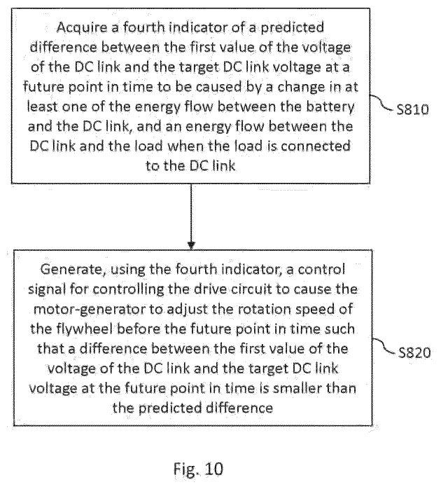

FIG. 10 is a flow diagram illustrating an example of a method by which processor 320 (performing the function of the controller 280 of the example embodiment of FIG. 3) responds to a predicted difference between the determined voltage of the DC link 160 and the target DC link voltage at a future point in time.

In S810 of FIG. 10, the processor 320 acquires a fourth indicator of a predicted difference between the first value of the voltage of the DC link 160 and the target DC link voltage at a future point in time to be caused by a change in at least one of the energy flow between the battery 250 and the DC link 160, and an energy flow between the DC link 160 and the load 270, when the load 270 is connected to the DC link 160. The fourth indicator may be determined based on anticipated requirements of the load 270. The fourth indicator may, as in the present example embodiment, be indicative of a predicted level of acceleration or deacceleration of the electric vehicle.

In S820 of FIG. 10, the processor 320 generates, using the fourth indicator, a control signal for controlling the drive circuit 140 to cause the motor-generator 130 to adjust the rotation speed of the flywheel 120 before the future point in time such that a difference between the first value of the voltage of the DC link 160 and the target DC link voltage at the future point in time is smaller than the predicted difference. In other words, a control signal is generated and sent to the drive circuit 140, directing it to vary the rotational speed of the stator 135 such that the rotational speed of the flywheel 120 changes, causing the voltage of the DC link 160 to converge towards the target DC link voltage over time. Thus, when the future point in time is reached, the difference between the first value of the voltage of the DC link 160 and the target DC link voltage is reduced.

By using the method of FIG. 10, the processor 320 can improve the response of the hybrid energy storage system 200 to abrupt load changes. For example, when the hybrid energy storage system 200 is used to power an electric vehicle, the hybrid energy storage system 200 may respond to information indicating that the vehicle is anticipated to accelerate abruptly, by drawing energy from the flywheel 120 to the DC link 160 before the acceleration occurs, so that the hybrid energy storage system 200 can fulfil the power requirement of this acceleration faster than if it responded only in reaction to the acceleration whilst it is occurring.

The processes of FIGS. 6 to 10 may be performed by processor 320 (acting as controller 280 and/or battery state sensor 255), which operates in accordance with computer-readable instructions when the computer program is executed by the processor 320. This computer program may be stored in a computer program product, such as a non-transitory, computer-readable storage medium in the form of a CD-ROM, DVDROM, etc. or a computer-readable signal carrying the computer-readable instructions.

In the foregoing description, example aspects are described with reference to several example embodiments. Accordingly, the specification should be regarded as illustrative. Similarly, the figures illustrated in the drawings, which highlight the functionality and advantages of the example embodiments, are presented for example purposes only. The architecture of the example embodiments is sufficiently flexible and configurable, such that it may be utilized (and navigated) in ways other than those shown in the accompanying figures.

Software embodiments of the examples presented herein may be provided as a computer program, or software, such as one or more programs having instructions or sequences of instructions, included or stored in an article of manufacture such as a machine-accessible or machine-readable medium, an instruction store, or computer-readable storage device, each of which can be non-transitory, in one example embodiment. The program or instructions on the non-transitory machine-accessible medium, machine-readable medium, instruction store, or computer-readable storage device, may be used to program a computer system or other electronic device. The machine-or computer-readable medium, instruction store, and storage device may include, but are not limited to, floppy diskettes, optical disks, and magneto-optical disks or other types of media/machine-readable medium/instruction store/storage device suitable for storing or transmitting electronic instructions. The techniques described herein are not limited to any particular software configuration. They may find applicability in any computing or processing environment. The terms “computer-readable”, “machine-accessible medium”, “machine-readable medium”, “instruction store”, and “computer-readable storage device” used herein shall include any medium that is capable of storing, encoding, or transmitting instructions or a sequence of instructions for execution by the machine, computer, or computer processor and that causes the machine/computer/computer processor to perform any one of the methods described herein. Furthermore, it is common in the art to speak of software, in one form or another (e.g. program, procedure, process, application, module, unit, logic, and so on), as taking an action or causing a result. Such expressions are merely a shorthand way of stating that the execution of the software by a processing system causes the processor to perform an action to produce a result.

Some embodiments may also be implemented by the preparation of application-specific integrated circuits, field-programmable gate arrays, or by interconnecting an appropriate network of conventional component circuits.

Some embodiments include a computer program product. The computer program product may be a storage medium or media, instruction store(s), or storage device(s), having instructions stored thereon or therein which can be used to control, or cause, a computer or computer processor to perform any of the procedures of the example embodiments described herein. The storage medium/instruction store/storage device may include, by example and without limitation, an optical disc, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer-readable medium or media, instruction store(s), or storage device(s), some implementations include software for controlling both the hardware of the system and for enabling the system or microprocessor to interact with a human user or other mechanism utilizing the results of the example embodiments described herein. Such software may include without limitation device drivers, operating systems, and user applications. Ultimately, such computer-readable media or storage device(s) further include software for performing example aspects of the invention, as described above.

Included in the programming and/or software of the system are software modules for implementing the procedures described herein. In some example embodiments herein, a module includes software, although in other example embodiments herein, a module includes hardware, or a combination of hardware and software.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

Further, the purpose of the Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

While this specification contains many specific embodiment details, these should not be construed as limitations on the scope of any inventions or of what may be claimed, but rather as descriptions of features specific to particular embodiments described herein. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

In certain circumstances, multitasking and parallel processing may be advantageous. Moreover, the separation of various components in the embodiments described above should not be understood as requiring such separation in all embodiments, and it should be understood that the described program components and systems can generally be integrated together in a single software product or packaged into multiple software products.

Having now described some illustrative embodiments, it is apparent that the foregoing is illustrative and not limiting, having been presented by way of example. In particular, although many of the examples presented herein involve specific combinations of apparatus or software elements, those elements may be combined in other ways to accomplish the same objectives. Acts, elements and features discussed only in connection with one embodiment are not intended to be excluded from a similar role in other embodiments or embodiments.

The apparatus and computer programs described herein may be embodied in other specific forms without departing from the characteristics thereof. The foregoing embodiments are illustrative rather than limiting of the described systems and methods. Scope of the apparatus and computer programs described herein is thus indicated by the appended claims, rather than the foregoing description, and changes that come within the meaning and range of equivalency of the claims are embraced therein.

1. A hybrid energy storage system comprising:
a flywheel energy storage device comprising:
a flywheel;
a motor-generator coupled to the flywheel;
a drive circuit configured to drive the motor-generator;
a battery coupled to the drive circuit via a DC link;
a battery state sensor configured to determine a state of the battery;
a voltage sensor configured to determine a voltage of the DC link; and
a controller operable to:
increase an energy flow between the battery and the DC link from a first power level to a target power level by controlling the drive circuit, based on the target power level, the determined voltage of the DC link, and the determined state of the battery, to cause the motor-generator to adjust a rotation speed of the flywheel such that the voltage of the DC link is changed to a target DC link voltage that causes the energy flow between the battery and the DC link to be at the target power level; and
decrease the energy flow between the battery and the DC link from a second power level to the target power level by controlling the drive circuit, based on the target power level, the determined voltage of the DC link and the determined state of the battery, to cause the motor-generator to adjust the rotation speed of the flywheel such that the voltage of the DC link is changed to the target DC link voltage.

2. The hybrid energy storage system of claim 1, wherein the battery state sensor is configured to determine, as the state of the battery, a first battery state parameter which is indicative of an open-circuit voltage of the battery, and a second battery state parameter which is indicative of an impedance of the battery.

3. The hybrid energy storage system of claim 2, wherein
the controller comprises a memory having a data array for correlating different n-tuples with respective values of the target DC link voltage that cause the energy flow between the battery and the DC link to be at a respective power level, where each n-tuple comprises respective values of the first battery state parameter, the second battery state parameter, power level of the energy flow between the battery and the DC link, and an indicator of a direction of the energy flow between the battery and the DC link, and
the controller is configured to control the drive circuit to cause the motor-generator to adjust the rotation speed of the flywheel such that the voltage of the DC link is changed to the target DC link voltage by:
using values of the determined first battery state parameter and the second battery state parameter, the target power level of the energy flow between the battery and the DC link, and an indication of a direction of the energy flow at the target power level between the battery and the DC link to determine a respective value of the target DC link voltage in the data array; and
controlling the drive circuit to cause the motor-generator to adjust the rotation speed of the flywheel to minimise a difference between the determined voltage of the DC link and the determined value of the target DC link voltage.

4. The hybrid energy storage system of claim 2, wherein the battery state sensor is configured to determine the first battery state parameter by performing processes of:
(i) receiving contemporaneously acquired measurements of a first current flowing between the DC link and a load connected to the DC link, a second current flowing between the DC link and the drive circuit, and a voltage of the DC link;
(ii) calculating, based on the contemporaneously acquired measurements of the first current and second current, a value of a third current flowing between the DC link and the battery;
(iii) repeating processes (i) and (ii) so that sets of measurements of the first current, the second current, and the voltage of the DC link contemporaneously acquired at different respective times are received, and a respective value of the third current is calculated for each of the sets of measurements; and
(iv) determining, as a value of the first battery state parameter, a received measurement of the voltage of the DC link of a set of the sets of measurements, for which set the calculated value of the third current is within a predetermined range of zero.

5. The hybrid energy storage system of claim 4, wherein the battery state sensor configured to determine the second battery state parameter by performing, after the determination of the value of the first battery state parameter in the performance of process (iv), processes of:
calculating a difference between the value of the first battery state parameter and a value of the voltage of the DC link measured at a predetermined time before or after the set of measurements comprising the value of the first battery state parameter was acquired;
receiving measurements, contemporaneously acquired at the predetermined time, of the first current flowing between the DC link and the load, and the second current flowing between the DC link and the drive circuit;
calculating, based on the measurements of the first current and second current contemporaneously acquired at the predetermined time, a value of the third current flowing between the DC link and the battery at the predetermined time; and
calculating a value of the second battery state parameter by dividing the calculated difference of the value of the first battery state parameter and the second value of the voltage of the DC link by the calculated value of the third current flowing between the DC link and the battery at the predetermined time.

6. The hybrid energy storage system of claim 1, wherein the controller is configured to maintain the energy flow between the battery and the DC link at the target power level by controlling the drive circuit, based on the target power level, the determined voltage of the DC link, and the determined state of the battery, to cause the motor-generator to regulate the rotation speed of the flywheel such that the voltage of the DC link is maintained at the target DC link voltage.

7. The hybrid energy storage system of claim 1, wherein:
the flywheel energy storage device comprises two or more pairs of counter-rotating flywheels, and respective motor-generators configured to drive each flywheel in each of the pairs of counter-rotating flywheels, and
the controller configured to:
increase the energy flow between the battery and the DC link from the first power level to the target power level by controlling the drive circuit, based on the target power level, the determined voltage of the DC link, and the determined state of the battery, to cause each of the respective motor-generators to adjust a rotation speed of their respective flywheel such that the voltage of the DC link is changed to the target DC link voltage;
decrease the energy flow between the battery and the DC link from the first power level to the target power level by controlling the drive circuit, based on the target power level, the determined voltage of the DC link and the determined state of the battery, to cause each respective motor-generator to adjust the rotation speed of their respective flywheel such that the voltage of the DC link is changed to the target DC link voltage.

8. The hybrid energy storage system of claim 1, wherein
the DC link is configured to exchange energy with a load when the load is connected to the DC link, and
the controller is configured to:
determine an indication of a predicted difference between the voltage of the DC link and the target DC link voltage at a future point in time to be caused by a change in at least one of the energy flow between the battery and the DC link, and an energy flow between the DC link and the load when the load is connected to the DC link; and
control the drive circuit, using the indication, to cause the motor-generator to adjust the rotation speed of the flywheel before the future point in time such that a difference between the voltage of the DC link and the target DC link voltage at the future point in time is smaller than the predicted difference.

9. The hybrid energy storage system of claim 1, wherein:
the motor-generator comprises a stator,
the drive circuit is configured to output an alternating voltage which generates a magnetic field in the stator to drive the motor-generator, wherein the drive circuit comprises a pulse width modulator configured to generate a pulse width modulation (PWM) signal to set a frequency of the alternating voltage, and
the controller is configured to introduce a phase shift into the alternating voltage by varying the PWM signal, based on a difference between the determined voltage of the DC link and the target DC link voltage, such that energy is transferred between the stator and the DC link to reduce the difference between the determined voltage of the DC link and the target DC link voltage.

10. The hybrid energy storage system of claim 9, wherein the controller is further configured to introduce the phase shift into the alternating voltage by adjusting a width of at least one pulse in the PWM signal based on the difference between the determined voltage of the DC link and the target DC link voltage.

11. The hybrid energy storage system of claim 10, wherein the controller is further configured to adjust the width of the at least one pulse of the PWM signal, based on the difference between the determined voltage of the DC link and the target DC link voltage, by:
in case the determined voltage of the DC link is greater than the target DC link voltage by at least a first predetermined amount, increase the width of one or more pulses of the PWM signal by an amount dependent on the difference between the voltage of the DC link and the target DC link voltage such that energy is transferred from DC link to the stator to reduce the difference; and
in case the determined voltage of the DC link is less than the target DC link voltage by at least a second predetermined amount, decrease the width of the one or more pulses of the PWM signal by an amount dependent on the difference between the voltage of the DC link and the target DC link voltage such that energy is transferred from the stator to the DC link to reduce the difference.

12. The hybrid energy storage system of claim 1, operable to power one or more electric motors of an electric vehicle to propel the electric vehicle.

13. An electric vehicle comprising the hybrid energy storage system of claim 1.

14. A computer-implemented method of generating control signals for controlling energy flow in a hybrid energy storage system, the hybrid energy storage system comprising:
a flywheel energy storage device comprising:
a flywheel;
a motor-generator coupled to the flywheel; and
a drive circuit arranged to drive the motor-generator; and
a battery coupled to the drive circuit via a DC link,
the method comprising:
acquiring a first indicator of a state of the battery;
acquiring a first value of a voltage of the DC link;
acquiring a second indicator indicating a target power level of an energy flow between the battery and the DC link;
acquiring a third indicator indicating a measured power level of the energy flow between the battery and the DC link;
comparing the target power level indicated by the second indicator with the measured power level indicated by the third indicator;
in case the target power level is greater than the measured power level, generating a control signal, based on the target power level, the first value of the voltage of the DC link and the first indicator of the state of the battery, for controlling the drive circuit to cause the motor-generator to adjust a rotation speed of the flywheel such that the voltage of the DC link is changed to a target DC link voltage that causes the energy flow between the battery and the DC link to increase to the target power level; and
in case the target power level is smaller than the measured power level, generating a control signal, based on the target power level, the first value of the voltage of the DC link and the first indicator of the state of the battery, for controlling the drive circuit to cause the motor-generator to adjust a rotation speed of the flywheel such that the voltage of the DC link is changed to a target DC link voltage that causes the energy flow between the battery and the DC link to decrease to the target power level.

15. The computer-implemented method of claim 14, wherein a first battery state parameter which is indicative of an open-circuit voltage of the battery, and a second battery state parameter which is indicative of an impedance of the battery, are acquired as the first indicator.

16. The computer-implemented method of claim 15, wherein the control signal is generated by:
using values of the first battery state parameter and the second battery state parameter, the target power level of the energy flow between the battery and the DC link, and an indication of a direction of the energy flow at the target power level between the battery and the DC link to determine a value of the target DC link voltage in a data array, wherein the data array is for correlating different n-tuples with respective values of the target DC link voltage that cause the energy flow between the battery and the DC link to be at a respective power level, where each n-tuple comprises respective values of the first battery state parameter, the second battery state parameter, power level of the energy flow between the battery and the DC link, and an indicator of a direction of the energy flow between the battery and the DC link; and
generating a control signal for controlling the drive circuit to cause the motor-generator to adjust the rotation speed of the flywheel to minimise a difference between the voltage of the DC link and the determined value of the target DC link voltage.

17. The computer-implemented method of claim 15 wherein acquiring the first battery state parameter as the first indicator comprises performing processes of:
(i) receiving contemporaneously acquired measurements of a first current flowing between the DC link and a load connected to the DC link, a second current flowing between the DC link and the drive circuit, and a voltage of the DC link;
(ii) calculating, based on the received measurements of the first current and second current, a value of a third current flowing between the DC link and the battery;
(iii) repeating (i) and (ii) so that sets of measurements of the first current, the second current, and the voltage of the DC link contemporaneously acquired at different respective times are received, and a respective value of the third current is calculated for each of the sets of measurements; and
(iv) determining, as a value of the first battery state parameter, a received measurement of the voltage of the DC link of a set of the sets of sets of measurements, for which set the calculated value of the third current is within a predetermined range of zero.

18. The computer-implemented method of claim 17, further comprising, after the determination of the value of the first battery state parameter made in the performance of process (iv), acquiring the second battery state parameter as the first indicator by:
calculating a difference between the value of the first battery state parameter and a second value of the voltage of the DC link measured at a predetermined time before or after the set of measurements comprising the value of the first battery state parameter was acquired;
receiving measurements, contemporaneously acquired at the predetermined time, of the first current flowing between the DC link and the load, and the second current flowing between the DC link and the drive circuit;
calculating, based on the measurements of the first current and second current contemporaneously acquired at the predetermined time, a value of the third current flowing between the DC link and the battery at the predetermined time; and
calculating a value of the second battery state parameter by dividing the calculated difference of the value of the first battery state parameter and the second value of the voltage of the DC link by the calculated value of the third current flowing between the DC link and the battery at the predetermined time.

19. The computer-implemented method of claim 14, further comprising:
in case the target power level equals the measured power level, generating a control signal, based on the target power level, the first value of the voltage of the DC link and the first indicator of the state of the battery, for controlling the drive circuit to cause the motor-generator to regulate a rotation speed of the flywheel such that the voltage of the DC link is set to a target DC link voltage that causes the energy flow between the battery and the DC link to be maintained at the target power level.

20. The computer-implemented method of any of claim, further comprising:
acquiring a fourth indicator of a predicted difference between the voltage of the DC link and the target DC link voltage at a future point in time to be caused by a change in at least one of the energy flow between the battery and the DC link, and an energy flow between the DC link and the load when the load is connected to the DC link; and
generating, using the fourth indicator, a control signal for controlling the drive circuit to cause the motor-generator to adjust the rotation speed of the flywheel before the future point in time such that a difference between the voltage of the DC link and the target DC link voltage at the future point in time is smaller than the predicted difference.

21. (canceled)

22. (canceled)

23. A hybrid energy storage system for powering a drive system of an electric vehicle, the hybrid energy storage system comprising:
a flywheel energy storage device comprising:
a flywheel;
a motor-generator coupled to the flywheel;
a drive circuit configured to drive the motor-generator;
a battery coupled to the drive circuit via a DC link; and
a controller operable in:
a first mode to control an energy flow between the flywheel energy storage device and the DC link while preventing an energy flow between the battery and the DC link; and
a second mode to control an energy flow between the flywheel energy storage device and the DC link, and a concurrent energy flow between the battery and the DC link.
